(19) United States
(12) Patent Application Publication
(10) Pub. No.: US 2014/0123190 A1
(43) Pub. Date: May 1, 2014

(54) CONTENT BASED USER INTERFACE

(71) Applicant: KT Corporation, Seongnam-si (KR)

(72) Inventors: Min-Sook SONG, Seoul (KR); Gyu-tae BAEK, Seoul (KR); Wang-Sung CHUN, Anyang-si (KR)

(73) Assignee: KT Corporation, Seongnam-si (KR)

(21) Appl. No.: 14/069,451

(22) Filed: Nov. 1, 2013

(30) Foreign Application Priority Data
Nov. 1, 2012 (KR) 10-2012-0123103

(51) Int. Cl. H04N 21/4227

(52) U.S. Cl. CPC H04N 21/4227
USPC 725/40

(57) ABSTRACT

In one example embodiment, a mobile device includes a data receiving unit configured to receive metadata regarding television content that is played by a television device; an icon displaying unit configured to: display a plurality of icons that are associated with the television content based at least in part on the metadata, and receive a touch input via at least one icon from among the plurality of icons; and a signal generating unit configured to generate a control signal regarding an operation of the television device based at least in part on the received touch input.

### TECHNICAL FIELD

The embodiments described herein pertain generally to user interface (UI) icons corresponding to television content.

### BACKGROUND

A remote control device, or remote controller, may be used to provide control of operations of one or more electronic devices from a remote location. By way of example, a hand-held, battery-operated remote controllers may be used to control operations of televisions, set top boxes (STBs), and various other home or consumer electronic devices that may be used for receiving, rendering, recording and/or playing audio, video, media content and the like.

### SUMMARY

In one example embodiment, a mobile device includes a data receiving unit configured to receive metadata regarding television content that is played by a television device; an icon displaying unit configured to: display a plurality of icons that are associated with the television content based at least in part on the metadata, and receive a touch input via at least one icon from among the plurality of icons; and a signal generating unit configured to generate a control signal regarding an operation of the television device based at least in part on the received touch input.

In another example embodiment, a method implemented by a mobile device having a user interface includes receiving metadata regarding television content that is played by a television device; displaying a plurality of icons that are associated with the television content based at least in part on the metadata; receiving a touch input via at least one icon from among the plurality of icons; and generating a control signal regarding an operation of the television device based at least in part on the received touch input.

In yet another example embodiment, a computer-readable storage medium having thereon computer-executable instructions that, in response to execution, cause one or more processors corresponding to a mobile device having a user interface to perform operations including: displaying the user interface that is associated with television content that is played by a television device based at least in part on metadata regarding the television content; receiving a touch input via at least one icon from among a plurality of icons included in the user interface; and generating a control signal regarding an operation of the display device based at least in part on the received touch input.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of a content based user interface may be implemented, in accordance with various embodiments described herein;

FIG. 2 shows an illustrative example of metadata associated with one or more embodiments of a content based user interface, in accordance with various embodiments described herein;

FIG. 3 shows an example of a mobile device by which one or more embodiments of a content based user interface may be implemented, in accordance with various embodiments described herein;

FIG. 4 shows another example of a mobile device by which one or more embodiments of a content based user interface may be implemented, in accordance with various embodiments described herein;

FIG. 5 shows still another example of a mobile device by which one or more embodiments of a content based user interface may be implemented, in accordance with various embodiments described herein;

FIG. 6 shows an example configuration of a mobile device by which at least portions of a content based user interface may be implemented, in accordance with various embodiments described herein;

FIG. 7 shows another example configuration of a mobile device by which at least portions of a content based user interface may be implemented, in accordance with various embodiments described herein;

FIG. 8 shows an example configuration of an icon control manager by which at least portions of a content based user interface may be implemented, in accordance with various embodiments described herein;

FIG. 9 shows an example processing flow of operations for implementing at least portions of a content based user interface, in accordance with various embodiments described herein;

FIG. 10 shows another example processing flow of operations for implementing at least portions of a content based user interface, in accordance with various embodiments described herein; and

FIG. 11 shows an illustrative computing embodiment, in which any of the processes and sub-processes of a content based user interface may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

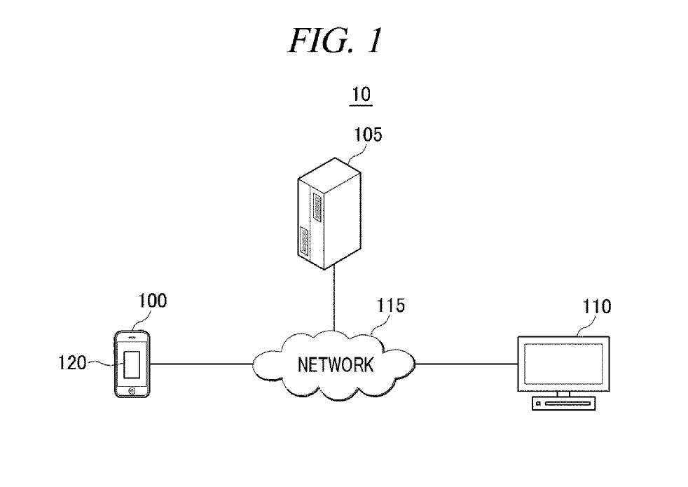

FIG. 1 shows an example system configuration 10 in which one or more embodiments of a content based user interface may be implemented, in accordance with various embodiments described herein. As depicted in FIG. 1, system configuration 10 may include, at least, a mobile device 100, a server 105, and a television device 110. At least two or more of mobile device 100, server 105, and television device 110 may be communicatively connected to each other via a network 115.

By way of example, but not limitation, network 115 may include a wired network such as a LAN (Local Area Network), a WAN (Wide Area Network), a VAN (Value Added Network) or the like, or various other wireless network such as a mobile radio communication network including at least one of a 3rd generation (3G) mobile telecommunications network, a 4th generation (4G) mobile telecommunications network, various other mobile telecommunications networks, a satellite network, WiBro (Wireless Broadband Internet), Mobile WiMAX, HSDPA (High Speed Downlink Packet Access), or the like. Alternatively, network 115 may include at least one of a near field communication (NEC), Bluetooth, or peer to peer (P2P) communication protocol.

Mobile device 100 may refer to a notebook, a personal computer, a smart phone, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal.

Server 105 may refer to one or more servers hosted and/or supported by a service providing organization or entity that provides real-time broadcasting services, video-on-demand (VOD) services, and/or user interactive services (e.g., games) to mobile device 100 and television device 110. Server 105 may be one of multiple hosted servers or other processing apparatuses that may be configured to receive one or more signals from mobile device 100 acting as a remote control device for television device 110; and to transmit, to television device 110, a control signal that executes control of the operation of television device 110 upon receiving the signal from mobile device 100. Non-limiting examples of server 105 may include an Internet service provider, i.e., ISP; application service provider, i.e., ASP; storage service provider, i.e., SSP; and television service provider, i.e., cable TV, DSL and DBS.

Television device 110 may refer to a television, a notebook computer, a personal computer, a smart phone, a tablet computer, a phablet device, or any other type of personal communication terminal that is capable of, at least, receiving and/or playing television content.

In accordance with some embodiments, television device 110 may be configured to transmit a request for television content to server 105. Further, television device 110 may be configured to receive at least the requested television content from server 105 and to play the received television content.

Server 105 may be further configured to transmit, to mobile device 100, a message that indicates that the requested television content has been transmitted to television device 110 and that television device 110 is ready to play, or is playing, the requested television content. In at least one example, the message may include a content identifier of the television content that is ready to be played, or is playing, on television device 110.

Mobile device 100 may be configured to transmit, to server 105, a request for metadata regarding television content that is currently being played, or has been played, on television device 110. In some embodiments, mobile device 100 may be configured to transmit the request for metadata to server 105 when mobile device 100 receives a message indicating that television device 110 is capable of playing the television content. By way of example, but not limitation, the metadata may include information pertaining to the television content, including, but not limited to: a title, a play time, a genre, a type, a display resolution, a director, an actor or actress.

Server 105 may be configured to transmit the metadata regarding the television content that is currently being played, or has been played, on television device 110 to mobile device 100. Mobile device 100 may be configured to receive the metadata from server 105. As a non-limiting example, mobile device 100 may be configured to receive the metadata from server 105 upon calling an application programming interface (API) function.

In some other embodiments, mobile device 100 may be configured to receive metadata that includes sub-metadata regarding television content from server 105. By way of example, but not limitation, mobile device 100 may be configured to receive the metadata generated by server 105, from a file transfer protocol (FTP) server that is communicatively coupled to mobile device 100 and server 105. Mobile device 100 may be configured to then select at least some of the sub-metadata that is associated with the television content that is currently being played, or has been played, on television device 110.

In some other embodiments, television device 110 may be configured to transmit, to mobile device 100, a message that indicates that television device 110 is capable of, and/or ready to play, the television content. Mobile device 100 may be configured to transmit, to television device 110, a request for the metadata regarding the television content that is currently being played, or has been played, on television device 110, when mobile device 100 receives the message from television device 110. Television device 110 may be configured to transmit, to mobile device 100, the metadata regarding the television content that is currently being played, or has been played, on television device 110. Mobile device 100 may be configured to receive the metadata from television device 110.

Mobile device 100 may also be configured to display a user interface 120 that includes multiple icons that are associated with the television content that is currently being played, or has been played, on television device 110. User Interface 120 may be displayed, based at least in part on the received metadata, on a display which is operatively coupled to mobile device 100. For example, the multiple icons of user interface 120 may be changed depending on a genre or a type of the television content that may be included in the received metadata. As a non-limiting example, mobile device 100 may be configured to generate the multiple icons of user interface 120 upon receiving the metadata, and to display the generated multiple icons on the display. Alternatively, mobile device 100 may be configured to generate, in advance, plural icons that correspond to various kinds of television content, and to store the generated plural icons in a memory that is communicatively coupled to mobile device 100. Mobile device 100 may be configured to then select some of the stored icons based on the received metadata and to display the selected icons on the display.

In some embodiments, mobile device 100 may be configured to read a genre of the television content from the received metadata. Mobile device 100 may be configured to then identify at least one of the stored/generated icons that correspond to the read genre of the television content, and to display the identified icon on the display. As a non-limiting example, if the received metadata indicates that the genre of the television content that is currently being played, or has been played, on television device 110 is sports, mobile device 100 may be configured to display at least one icon that is associated with a hyper link to a web site introducing sports news or sports players. By way of another example, but not limitation, if the genre of the television content that is currently being played, or has been played, on television device 110 is a horror movie, mobile device 100 may be configured to display at least one icon that is associated with a hyper link to an internet market web site to sell multiple horror items or a web page providing a synopsis of the horror movie.

In some embodiments, mobile device 100 may be configured to read a type of the television content from the received metadata. Mobile device 100 may be configured to then determine at least one icon according to the read type of the television content and to display the determined icon on the display. By way of example, but not limitation, the type of the television content may include at least one of a real-time broadcasting type, a video-on-demand type, a music playing type, a web service type, or an interactive service type. By way of example, if the type of the television content that is currently being played, or has been played, on television device 110 is a real-time broadcasting type, mobile device 100 may be configured to display, on the display, a channel up icon, a channel down icon, a volume up icon and a volume down icon which are necessary for control of playing of real-time broadcasting content. Alternatively, if the type of the television content that is currently being played, or has been played, on television device 110 is a music playing type, mobile device 100 may be configured to display, on the display, a play and pause icon, a stop icon, a forward icon and a backward icon which are necessary for control of playing of music content.

In some embodiments, mobile device 100 may be configured to display at least one personalized icon based at least in part on a viewing log of a user of mobile device 100 and television device 110 on the display. By way of example, mobile device 100 may be configured to receive the viewing log from server 105 or television device 110 and to store the viewing log in a memory. The viewing log may include titles of television content that is frequently played by television device 110 or channel numbers assigned to channels that are frequently selected by television device 110. Further, mobile device 100 may be configured to display the personalized icons that are associated with the channel that is frequently selected by television device 110, or the television content that is frequently played by television device 110.

Further, mobile device 100 may be configured to receive a touch input to the display with respect to at least two icons among the displayed multiple icons. By way of example, but not limitation, the display may include a touch screen that has a touch-sensitive surface coupled to mobile device 100. The touch screen may be implemented by using liquid crystal display (LCD) technology, light emitting diode (LED) technology, or light emitting polymer display (LPD) technology. Further, as a non-limiting example, a user of mobile device 100 may make the touch input to the touch screen using any suitable object or appendage, such as a stylus, finger, and so forth. Mobile device 100 may recognize the touch input by using one or more multiple touch sensitivity technologies, including but not limited to capacitive, resistive, infrared, and surface acoustic wave technologies, as well as other proximity sensor arrays or other elements for determining one or more points of contact with the touch screen.

Further, mobile device 100 may be configured to generate a control signal regarding an operation of television device 110 based at least in part on the received touch input. Mobile device 100 may be configured to generate the control signal that is associated with an operation or a function corresponding to the touched icon. By way of example, but not limitation, if mobile device 100 receives a touch input to a channel up icon, mobile device 100 may be configured to generate a control signal that requests for server 105 to transmit a control signal that makes television device 110 to change a channel number to television device 110. Alternatively, if mobile device 100 received a touch input to an icon that is associated with a hyper link to a web site introducing sports news, mobile device 100 may be configured to generate a control signal that requests for server 105 to transmit a control signal that makes television device 110 to call the web site and display the sports news web page to television device 110.

Further, mobile device 100 may be configured to transmit the generated control signal to server 105 via network 115. Server 105 may be configured to receive the control signal. Further, server 105 may be configured to then transmit the control signal that makes television device 110 to execute the operation or function corresponding to the touched icon to television device 110. Further, television device 110 may be configured to receive the control signal from server 105 and then, the operation or function corresponding to the touched icon may be executed on television device 110. By way of example, but not limitation, television device 110 may be configured to receive the control signal that requests to change a channel number from server 105, and then, new content corresponding to the changed channel number is played by television device 110. By way of another example, television device 110 may be configured to receive the control signal that requests to call the web site providing sports news, and then, the web site is displayed by a web browser which is installed in television device 110.

In some other embodiments, mobile device 100 may be configured to transmit the generated control signal to television device 110 via network 115. Television device 110 may be configured to receive the control signal from mobile device 100 and then, the operations of television device 110 may be controlled by the received control signal.

In some embodiments, mobile device 100 may be configured to host an application that controls operations of mobile device 100. By way of example, but not limitation, after the application is executed on mobile device 100, at least one of receiving of the metadata, displaying of the multiple icons or generating of the control signals by mobile device 100 may be performed.

Thus, FIG. 1 shows an example system configuration 10 in which one or more embodiments of a content based user interface may be implemented, in accordance with various embodiments described herein.

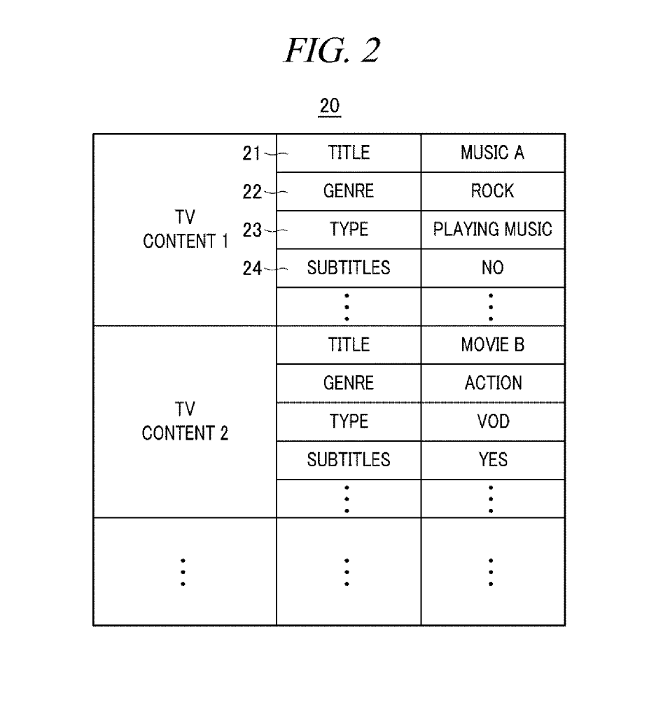

FIG. 2 shows an illustrative example of metadata associated with one or more embodiments of a content based user interface, in accordance with various embodiments described herein. Mobile device 100 may be configured to receive metadata 20 regarding some television content from server 105 or television device 110. By way of example, server 105 or television device 110 may be configured to generate a kind of metadata table or metadata database including metadata 20 and to transmit it to mobile device 100. By way of example, but not limitation, as depicted in FIG. 2, metadata 20 of each television content may include information regarding a title 21, a genre 22, a type 23, and subtitles 24 of the each television content. However, the kinds of information included in metadata 20 may be changed according to the television content.

Thus, FIG. 2 shows an illustrative example of metadata 20 associated with one or more embodiments of a content based user interface, in accordance with various embodiments described herein.

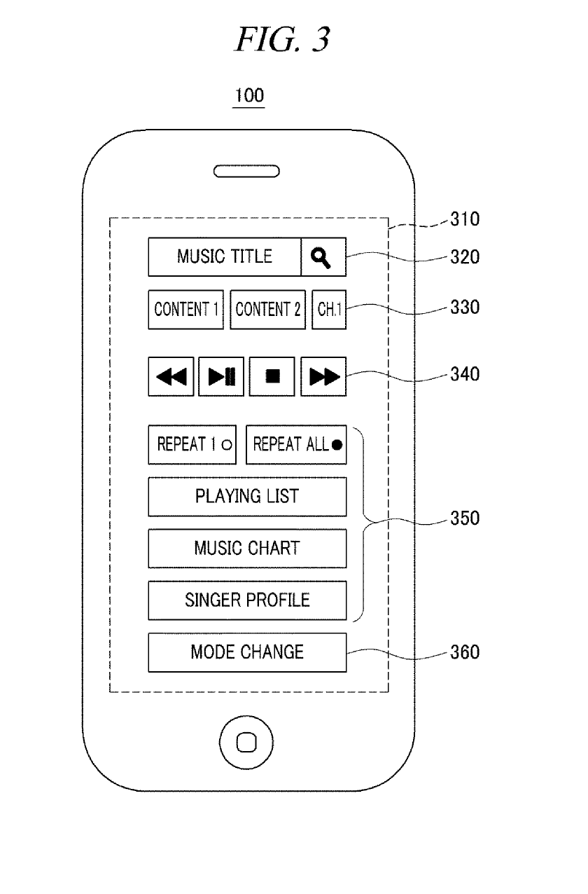

FIG. 3 shows an example of a mobile device by which one or more embodiments of a content based user interface may be implemented, in accordance with various embodiments described herein. By way of example, it may be assumed that television device 110 may play music content and mobile device 100 may receive metadata regarding the music content from at least one of server 105 or television device 110. Non-limiting examples of the music content may include “music on demand”, “satellite radio”, etc. As depicted in FIG. 3, mobile device 100 may be configured to display a user interface 310 that includes multiple icons. By way of example, mobile device 100 may be configured to display a searching box icon 320 that is associated with a web searching about the music content that is played by television device 110. Mobile device 100 may be configured to read a title of the music content from the metadata and to automatically display the title of the music content on searching box icon 320.

Further, as depicted in FIG. 3, mobile device 100 may be configured to display multiple personalized icons 330 based on a viewing log of mobile device 100 and television device 110. By way of example, one of multiple personalized icons 330 is associated with content no. 1 which is frequently played by television device 110. So, if the personalized icon 330 is selected, television device 110 may be configured to play the content no. 1 or to be in a state capable of reproducing the content no. 1.

Further, as depicted in FIG. 3, by way of example, mobile device 100 may be configured to display playing control icons 340 including a backward icon, a play and pause icon, a stop icon, and a forward icon, which are necessary for control of playing of the music content. Since mobile device 100 receives the metadata regarding the music content and realizes that the music content is played by television device 110 now, mobile device 100 may be configured to display playing control icons 340 that are necessary for control of playing of the music content.

Further, as depicted in FIG. 3, mobile device 100 may be configured to display additional information icons 350 based on the received metadata. By way of example, additional information icons 350 may include an icon that is associated with a repetition function of the music content, an icon that is associated with showing a music playing list, an icon that is associated with a hyper link to a web site providing a music favorite chart, or an icon that is associated with describing a profile of a singer of the music content. Since mobile device 100 receives the metadata regarding the music content and realizes that the music content is played by television device 110 now, mobile device 100 may be configured to display additional information icons 350 that are associated with the music content, such as the repetition function, the music playing list, the music favorite chart, or the profiles of singers.

Further, as depicted in FIG. 3, mobile device 100 may be configured to display a mode change icon 360 to change at least some mode of user interface 310. By way of example, if mode change icon 360 is selected, playing control icons 340 and additional information icons 350 disappear and an ordinary remote control user interface including number keys, channel control keys and volume control keys may be displayed on mobile device 100.

Thus, FIG. 3 shows an example of mobile device 100 by which one or more embodiments of a content based user interface may be implemented, in accordance with various embodiments described herein.

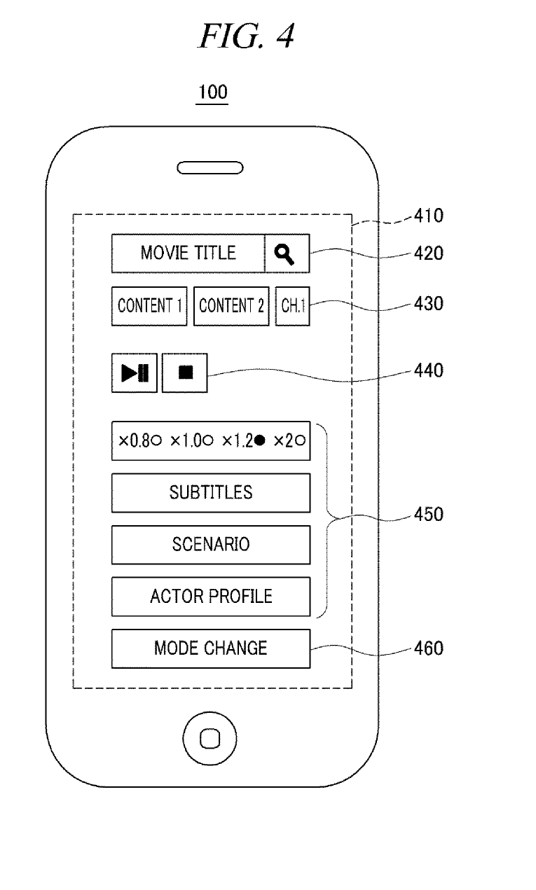

FIG. 4 shows another example of a mobile device by which one or more embodiments of a content based user interface may be implemented, in accordance with various embodiments described herein. By way of example, it may be assumed that television device 110 may play a video on demand (VOD) movie content and mobile device 100 may receive metadata regarding the VOD movie content from at least one of server 105 or television device 110. As depicted in FIG. 4, mobile device 100 may be configured to display a user interface 410 that includes multiple icons. By way of example, mobile device 100 may be configured to display a searching box icon 420 that is associated with a web searching about the VOD movie content that is played by television device 110. Mobile device 100 may be configured to read a title of the VOD movie content from the metadata and to automatically display the title of the VOD movie content on searching box icon 420.

Further, as depicted in FIG. 4, mobile device 100 may be configured to display multiple personalized icons 430 based on a viewing log of mobile device 100 and television device 110. By way of example, one of multiple personalized icons 430 is associated with content no. 2 which is frequently played by television device 110. So, if the personalized icon 430 is selected, television device 110 may be configured to play the content no. 2 or to be in a state capable of reproducing the content no. 2.

Further, as depicted in FIG. 4, by way of example, mobile device 100 may be configured to display playing control icons 440 including a play and pause icon and a stop icon, which are necessary for control of playing of the VOD movie content. Since mobile device 100 receives the metadata regarding the VOD movie content and realizes that the VOD movie content is played by television device 110 now, mobile device 100 may be configured to display playing control icons 440 that are necessary for control of playing of the VOD movie content.

Further, as depicted in FIG. 4, mobile device 100 may be configured to display additional information icons 450 based on the received metadata. By way of example, additional information icons 450 may include an icon that is associated with a playing speed of the VOD movie content, an icon that is associated with showing subtitles of the VOD movie content, an icon that is associated with describing a scenario of the VOD movie content, or an icon that is associated with a hyper link to a web site providing a profile of an actor appearing in the VOD movie content. Since mobile device 100 receives the metadata regarding the VOD movie content and realizes that the VOD movie content is played by television device 110 now, mobile device 100 may be configured to display additional information icons 450 that are associated with the VOD movie content, such as the playing speed, the subtitles, the scenario, or the profiles of actors.

Further, as depicted in FIG. 4, mobile device 100 may be configured to display a mode change icon 460 to change at least some mode of user interface 410. By way of example, if mode change icon 460 is selected, playing control icons 440 and additional information icons 450 disappear and an ordinary remote control user interface including number keys, channel control keys and volume control keys may be displayed on mobile device 100.

Thus, FIG. 4 shows another example of mobile device 100 by which one or more embodiments of a content based user interface may be implemented, in accordance with various embodiments described herein.

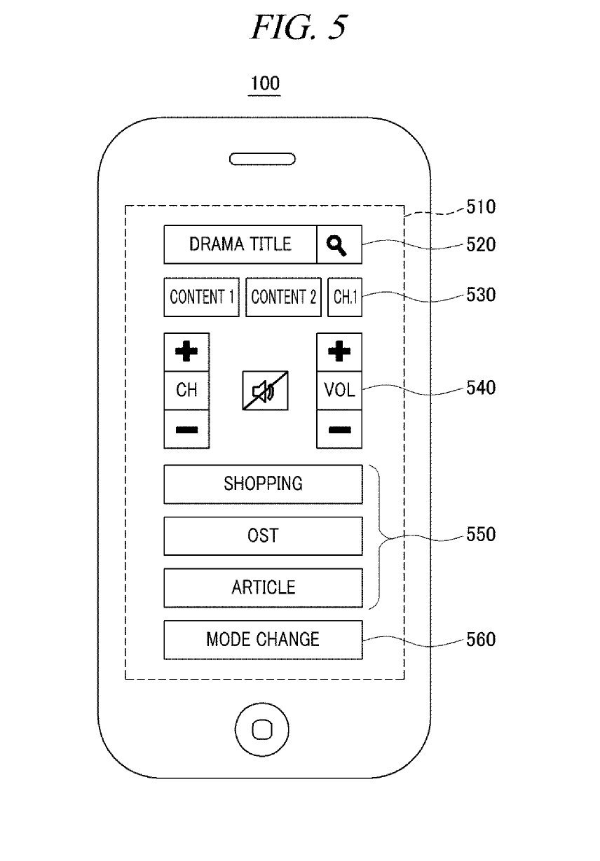

FIG. 5 shows still another example of a mobile device by which one or more embodiments of a content based user interface may be implemented, in accordance with various embodiments described herein. By way of example, it may be assumed that television device 110 may play a real-time broadcasting content (e.g., reality television broadcasting, television shopping, etc) and mobile device 100 may receive metadata regarding the real-time broadcasting content from at least one of server 105 or television device 110. As depicted in FIG. 5, mobile device 100 may be configured to display a user interface 510 that includes multiple icons. By way of example, mobile device 100 may be configured to display a searching box icon 520 that is associated with a web searching about the real-time broadcasting content that is played by television device 110. Mobile device 100 may be configured to read a title of the real-time broadcasting content (e.g., a title of the drama content) from the metadata and to automatically display the title of the real-time broadcasting content on searching box icon 520.

Further, as depicted in FIG. 5, mobile device 100 may be configured to display multiple personalized icons 530 based on a viewing log of mobile device 100 and television device 110. By way of example, one of multiple personalized icons 530 is associated with a channel no. 1 which is frequently selected by television device 110. So, if the personalized icon 530 is selected, a channel played by television device 110 may be changed to the channel no. 1.

Further, as depicted in FIG. 5, by way of example, mobile device 100 may be configured to display playing control icons 540 including a channel up icon, a channel down icon, a volume up icon, a volume down icon and a mute icon, which are necessary for control of playing of the real-time broadcasting content. Since mobile device 100 receives the metadata regarding the real-time broadcasting content and realizes that the real-time broadcasting content is played by television device 110 now, mobile device 100 may be configured to display playing control icons 540 that are necessary for control of playing of the real-time broadcasting content.

Further, as depicted in FIG. 5, mobile device 100 may be configured to display additional information icons 550 based on the received metadata. By way of example, additional information icons 550 may include an icon that is associated with a hyper link to an internet shopping web site to sell items or objects appearing in the real-time broadcasting content (e.g., drama content), an icon that is associated with providing an original sound track of the real-time broadcasting content, or an icon that is associated with showing an article regarding the real-time broadcasting content. Since mobile device 100 receives the metadata regarding the real-time broadcasting content and realizes that the real-time broadcasting content is played by television device 110 now, mobile device 100 may be configured to display additional information icons 550 that are associated with the real-time broadcasting content, such as the objects appearing in the real-time broadcasting content, the original sound track, or the article regarding the real-time broadcasting content.

Further, as depicted in FIG. 5, mobile device 100 may be configured to display a mode change icon 560 to change at least some mode of user interface 510. By way of example, if mode change icon 560 is selected, playing control icons 540 and additional information icons 550 disappear and an ordinary remote control user interface including number keys, channel control keys and volume control keys may be displayed on mobile device 100.

Thus, FIG. 5 shows still another example of mobile device 100 by which one or more embodiments of a content based user interface may be implemented, in accordance with various embodiments described herein.

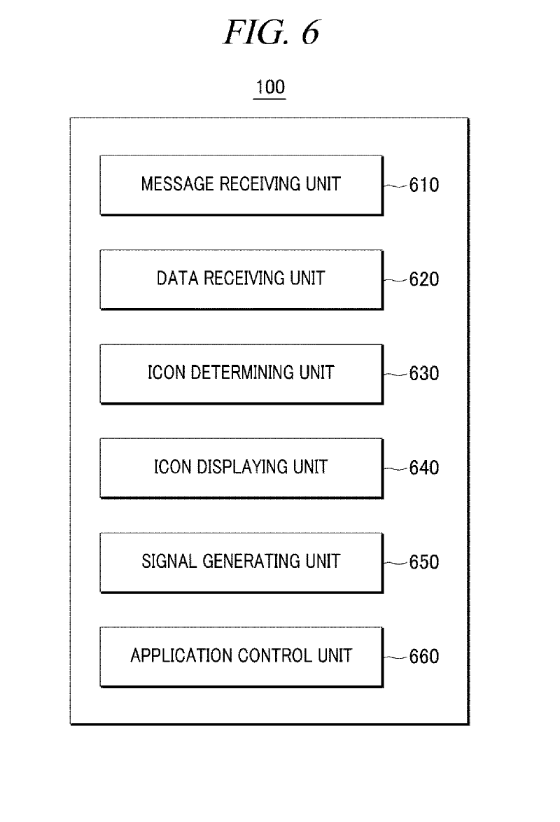

FIG. 6 shows an example configuration of a mobile device by which at least portions of a content based user interface may be implemented, in accordance with various embodiments described herein. As depicted in FIG. 6, mobile device 100 may include a message receiving unit 610, a data receiving unit 620, an icon determining unit 630, an icon displaying unit 640, a signal generating unit 650 and an application control unit 660. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of message receiving unit 610, data receiving unit 620, icon determining unit 630, icon displaying unit 640, signal generating unit 650 and application control unit 660 may be included in an instance of an application hosted on mobile device 100.

In some embodiments, message receiving unit 610 may be configured to receive, from server 105, a message that indicates that television device 110 is ready to play, or is playing, television content. In some other embodiments, message receiving unit 610 may be configured to receive, from television device 110, the message indicating that television device 110 is ready to play, or is playing, the television content.

In some embodiments, data receiving unit 620 may be configured to transmit a request for metadata regarding the television content that is played by television device 110 to server 105. By way of example, data receiving unit 620 may be configured to transmit the request for the metadata to server 105, when message receiving unit 610 receives the message. Further, data receiving unit 620 may be configured to receive, from server 105, the metadata regarding the television content that is played by television device 110. By way of example, but not limitation, data receiving unit 620 may be configured to receive the metadata from server 105 upon calling an application programming interface (API) function. By way of example, but not limitation, the metadata may include information pertaining to the television content, including, but not limited to: a title, a play time, a genre, a type, a display resolution, a director, an actor or actress.

In some other embodiments, data receiving unit 620 may be configured to transmit, to television device 110, the request for the metadata regarding the television content that is played by television device 110, when message receiving unit 610 receives the message. Further, data receiving unit 620 may be configured to receive the metadata regarding the television content from television device 110.

Icon determining unit 630 may be configured to determine multiple icons to be displayed based at least in part on the metadata received by data receiving unit 620. In some embodiments, icon determining unit 630 may be configured to read genre of the television content from the metadata. Further, icon determining unit 630 may be configured to then identify icons that are associated with the television content played by television device 110 based on the read genre of the television content. In some other embodiments, icon determining unit 630 may be configured to read type of the television content from the metadata. By way of example, but not limitation, the type of the television content may include at least one of a real-time broadcasting type, a video-on-demand type, a music playing type, a web service type, or an interactive service type. Further, icon determining unit 630 may be configured to then identify icons that are associated with the television content played by television device 110 based on the read type of the television content.

By way of example, but not limitation, icon determining unit 630 may be configured to generate the multiple icons upon receiving the metadata by data receiving unit 620. Alternatively, icon determining unit 630 may be configured to select the multiple icons from among plural icons that are generated, in advance, according to various kinds of television content and stored in a memory.

In some other embodiments, data receiving unit 620 may be configured to receive metadata including sub-metadata, each of which is associated with television content. Icon determining unit 630 may be configured to select at least some sub-metadata that is associated with the television content that is currently being played, or has been played, on television device 110 from among the multiple sub-metadata. Then, icon determining unit 630 may be configured to determine multiple icons to be displayed based at least in part on the selected sub-metadata.

Icon displaying unit 640 may be configured to display the multiple icons which are associated with the television content played by television device 110. By way of example, icon displaying unit 640 may include a touch screen that has a touch-sensitive surface coupled to mobile device 100. By way of example, but not limitation, the touch screen may be implemented by using liquid crystal display (LCD) technology, light emitting diode (LED) technology, or light emitting polymer display (LPD) technology.

Further, icon displaying unit 640 may be configured to receive a touch input via at least one icon from among the displayed multiple icons. By way of example, but not limitation, a user of mobile device 100 may make the touch input to the icon displayed by icon displaying unit 640 using any suitable object or appendage, such as a stylus, finger, and so forth. Icon displaying unit 640 may be configured to recognize the touch input by using one or more multiple touch sensitivity technologies, including but not limited to capacitive, resistive, infrared, and surface acoustic wave technologies, as well as other proximity sensor arrays or other elements for determining one or more points of contact with icon displaying unit 640.

Further, icon displaying unit 640 may be configured to display at least one personalized icon based at least in part on a viewing log of a user of mobile device 100 and television device 110. By way of example, the viewing log may include titles of television content that is frequently played by television device 110 or channel numbers assigned to channels that are frequently selected by television device 110.

Signal generating unit 650 may be configured to generate a control signal regarding an operation of television device 110 based at least in part on the touch input to the at least one icon. By way of example, signal generating unit 650 may be configured to generate a control signal that requests for server 105 to transmit a control signal to television device 110 to execute an operation that is associated with the touched at least one icon. Further, in some embodiments, signal generating unit 650 may be configured to transmit the generated control signal to server 105 via network 115. In some other embodiments, signal generating unit 650 may be configured to transmit the generated control signal to television device 110 directly.

Application control unit 660 may be configured to host an application that controls operations of at least one of message receiving unit 610, data receiving unit 620, icon determining unit 630, icon displaying unit 640, or signal generating unit 650. By way of example, in a state where application control unit 660 activates the application on mobile device 100, operations of all of message receiving unit 610, data receiving unit 620, icon determining unit 630, icon displaying unit 640 and signal generating unit 650 are executed on mobile device 100.

Thus, FIG. 6 shows an example configuration of mobile device 100 by which at least portions of a content based user interface may be implemented, in accordance with various embodiments described herein.

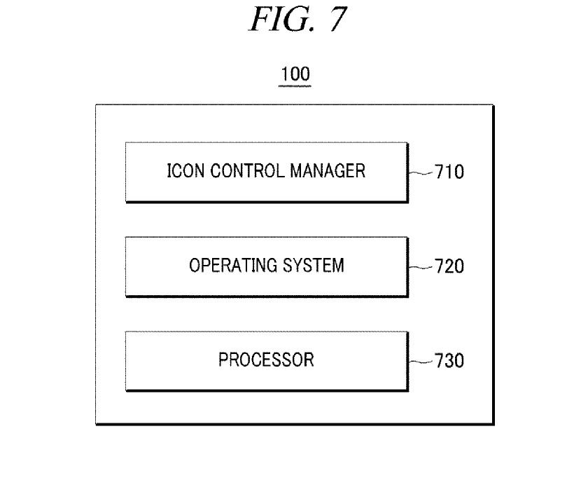

FIG. 7 shows another example configuration of a mobile device by which at least portions of a content based user interface may be implemented, in accordance with various embodiments described herein. As depicted in FIG. 7, mobile device 100 may include an icon control manager 710, an operating system 720 and a processor 730. Icon control manager 710 may be an application adapted to operate on operating system 720 such that the content based user interface as described herein may be provided. Operating system 720 may allow icon control manager 710 to manipulate processor 730 to implement the content based user interface as described herein.

Thus, FIG. 7 shows another example configuration of mobile device 100 by which at least portions of a content based user interface may be implemented, in accordance with various embodiments described herein.

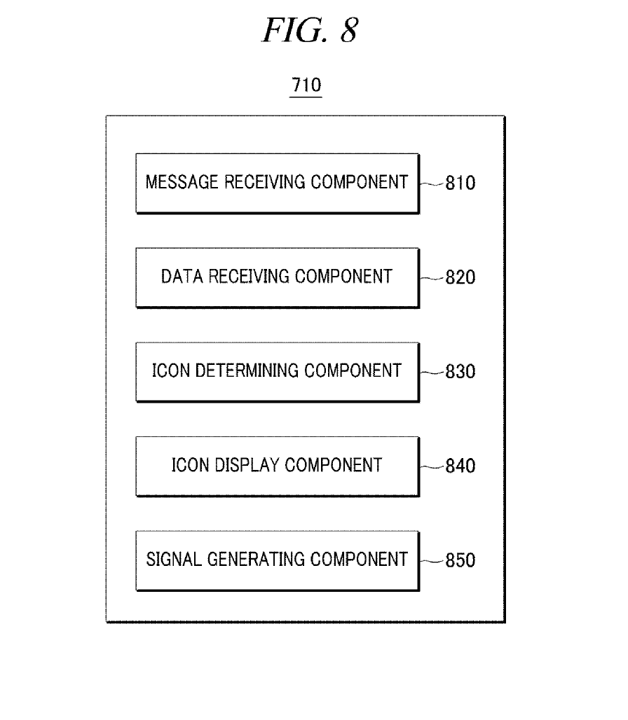

FIG. 8 shows an example configuration of an icon control manager by which at least portions of a content based user interface may be implemented, in accordance with various embodiments described herein. As depicted in FIG. 8, icon control manager 710 may include a message receiving component 810, a data receiving component 820, an icon determining component 830, an icon display component 840 and a signal generating component 850.

Message receiving component 810 may be configured to receive, from server 105, a message that indicates that television device 110 is ready to play, or is playing, television content. In some other embodiments, message receiving component 810 may be configured to receive, from television device 110, the message indicating that television device 110 is ready to play, or is playing, the television content.

In some embodiments, data receiving component 820 may be configured to transmit a request for metadata regarding the television content that is played by television device 110 to server 105. By way of example, data receiving component 820 may be configured to transmit the request for the metadata to server 105, when message receiving component 810 receives the message. Further, data receiving component 820 may be configured to receive, from server 105, the metadata regarding the television content that is played by television device 110. By way of example, but not limitation, data receiving component 820 may be configured to receive the metadata from server 105 upon calling an application programming interface (API) function. By way of example, but not limitation, the metadata may include information pertaining to the television content, including, but not limited to: a title, a play time, a genre, a type, a display resolution, a director, an actor or actress.

In some other embodiments, data receiving component 820 may be configured to transmit, to television device 110, the request for the metadata regarding the television content that is played by television device 110, when message receiving component 810 receives the message. Further, data receiving component 820 may be configured to receive the metadata regarding the television content from television device 110.

Icon determining component 830 may be configured to determine multiple icons to be displayed based at least in part on the metadata received by data receiving component 820. In some embodiments, icon determining component 830 may be configured to read genre of the television content from the metadata. Further, icon determining component 830 may be configured to then identify icons that are associated with the television content played by television device 110 based on the read genre of the television content. In some other embodiments, icon determining component 830 may be configured to read type of the television content from the metadata. By way of example, but not limitation, the type of the television content may include at least one of a real-time broadcasting type, a video-on-demand type, a music playing type, a web service type, or an interactive service type. Further, icon determining component 830 may be configured to then identify icons that are associated with the television content played by television device 110 based on the read type of the television content.

By way of example, but not limitation, icon determining component 830 may be configured to generate the multiple icons upon receiving the metadata by data receiving component 820. Alternatively, icon determining component 830 may be configured to select the multiple icons from among plural icons that are generated, in advance, according to various kinds of television content and stored in a memory.

In some other embodiments, data receiving component 820 may be configured to receive metadata including sub-metadata, each of which is associated with television content. Icon determining component 830 may be configured to select at least some sub-metadata that is associated with the television content that is currently being played, or has been played, on television device 110 from among the multiple sub-metadata. Then, icon determining component 830 may be configured to determine multiple icons to be displayed based at least in part on the selected sub-metadata.

Icon display component 840 may be configured to display the multiple icons which are associated with the television content that is currently being played, or has been played, on television device 110. Further, icon display component 840 may be configured to receive a touch input via at least one icon from among the displayed multiple icons.

Further, icon display component 840 may be configured to display at least one personalized icon based at least in part on a viewing log of a user of mobile device 100 and television device 110. By way of example, the viewing log may include titles of television content that is frequently played by television device 110 or channel numbers assigned to channels that are frequently selected by television device 110.

Signal generating component 850 may be configured to generate a control signal regarding an operation of television device 110 based at least in part on the touch input to the at least one icon. By way of example, signal generating component 850 may be configured to generate a control signal that requests for server 105 to transmit a control signal to television device 110 to execute an operation that is associated with the touched at least one icon. Further, in some embodiments, signal generating component 850 may be configured to transmit the generated control signal to server 105 via network 115. In some other embodiments, signal generating component 850 may be configured to transmit the generated control signal to television device 110 directly.

Thus, FIG. 8 shows an example configuration of icon control manager 710 by which at least portions of a content based user interface may be implemented, in accordance with various embodiments described herein.

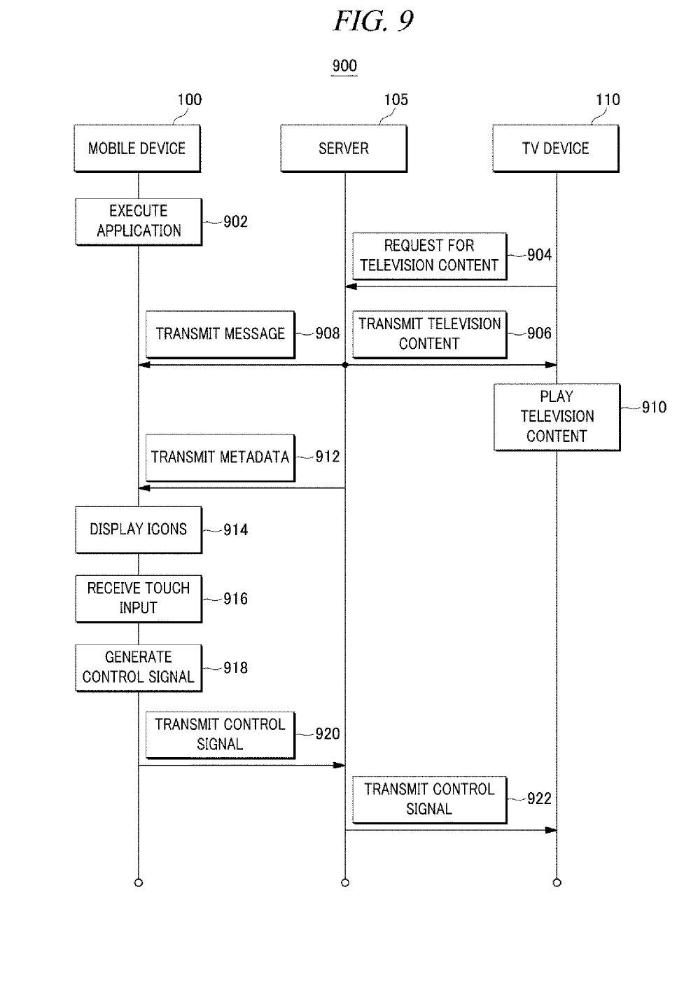

FIG. 9 shows an example processing flow 900 of operations for implementing at least portions of a content based user interface, in accordance with various embodiments described herein. The operations of processing flow 900 may be implemented in system configuration 10 including mobile device 100, server 105 and television device 110, as illustrated in FIG. 1. An example process may include one or more operations, actions, or functions as illustrated by one or more blocks 902, 904, 906, 908, 910, 912, 914, 916, 918, 920 and/or 922. Although illustrated as discrete blocks, various blocks may be divided into additional blocks, combined into fewer blocks, or eliminated, depending on the desired implementation. Processing may begin at block 902.

Block 902 (Execute Application) may refer to mobile device 100 executing an application for executing at least one of receiving of metadata, determining of multiple icons based on the metadata, displaying of the multiple icons or generating of control signals associated with the multiple icons by mobile device 100. Processing may proceed from block 902 to block 904.

Block 904 (Request for Television Content) may refer to television device 110 transmitting a request for television content to server 105 via network 115. Processing may proceed from block 904 to block 906.

Block 906 (Transmit Television Content) may refer to server 105 transmitting the television content requested at block 904 to television device 110 via network 115. Processing may proceed from block 906 to block 908.

Block 908 (Transmit Message) may refer to server 105 transmitting, to mobile device 100, a message that indicates that the television content is transmitted to television device 110 and television device 110 is capable of reproducing of the television content. Processing may proceed from block 908 to block 910.

Block 910 (Play Television Content) may refer to television device 110 receiving the requested television content and reproducing the received television content. Processing may proceed from block 910 to block 912.

Block 912 (Transmit Metadata) may refer to server 105 transmitting, to mobile device 100, metadata regarding the television content that is played by television device 110. At block 912, mobile device 100 may transmit a request for the metadata to server 105, when mobile device 100 receives the message from server 105 at block 908. Then, server 105 may transmit the metadata regarding the television content in response to the request. By way of example, but not limitation, the metadata may include information pertaining to the television content, including, but not limited to: a title, a play time, a genre, a type, a display resolution, a director, an actor or actress. Processing may proceed from block 912 to block 914.

Block 914 (Display Icons) may refer to mobile device 100 displaying multiple icons that are associated with the television content played by television device 110. At block 914, mobile device 100 may determine the multiple icons that are associated with the television content played by television device 110 based at least in part on the metadata received at block 912. Further, mobile device 100 may display the determined multiple icons on a display communicatively coupled to mobile device 100. Processing may proceed from block 914 to block 916.

Block 916 (Receive Touch Input) may refer to mobile device 100 receiving a touch input via at least on icon from among the multiple icons displayed at block 914. By way of example, but not limitation, a user of mobile device 100 may make the touch input to the icon using any suitable object or appendage, such as a stylus, finger, and so forth. Mobile device 100 may recognize the touch input by using one or more multiple touch sensitivity technologies, including but not limited to capacitive, resistive, infrared, and surface acoustic wave technologies, as well as other proximity sensor arrays or other elements for determining one or more points of contact with mobile device 100. Processing may proceed from block 916 to block 918.

Block 918 (Generate Control Signal) may refer to mobile device 100 generating a control signal regarding an operation of television device 110 based at least in part on the touch input to the at least one icon, which is received at block 916. By way of example, at block 918, mobile device 100 may generate a control signal that requests for server 105 to transmit a control signal to television device 110 to execute an operation that is associated with the touched icon. Processing may proceed from block 918 to block 920.

Block 920 (Transmit Control Signal) may refer to mobile device 100 transmitting the control signal regarding the operation of television device 110, which is generated at block 918, to server 105. Processing may proceed from block 920 to block 922.

Block 922 (Transmit Control Signal) may refer to server 105 transmitting a control signal to television device 110 upon receiving the control signal at block 920. By way of example, at block 922, server 105 may transmit, to television device 110, the control signal that makes television device 110 to execute the operation that is associated with the touched icon based on the control signal received at block 920. Then, television device 110 may receive the control signal from server 105 and execute the operation that is associated with the touched icon.

Thus, FIG. 9 shows an example processing flow of operations for implementing at least portions of a content based user interface, in accordance with various embodiments described herein.

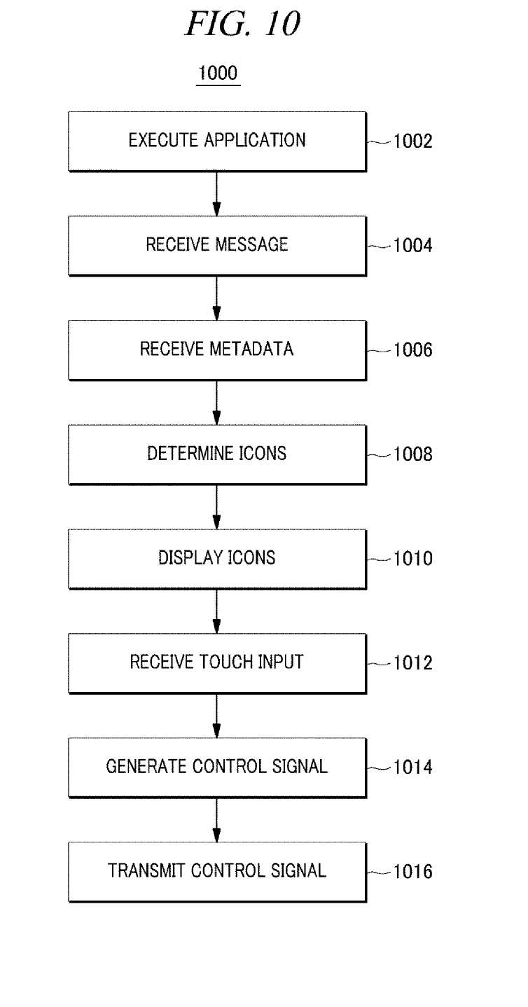

FIG. 10 shows another example processing flow 1000 of operations for implementing at least portions of a content based user interface, in accordance with various embodiments described herein. The operations of processing flow 1000 may be implemented in mobile device 100 including message receiving unit 610, data receiving unit 620, icon determining unit 630, icon displaying unit 640, signal generating unit 650 and application control unit 660 as illustrated in FIG. 6. An example process may include one or more operations, actions, or functions as illustrated by one or more blocks 1002, 1004, 1006, 1008, 1010, 1012, 1014 and/or 1016. Although illustrated as discrete blocks, various blocks may be divided into additional blocks, combined into fewer blocks, or eliminated, depending on the desired implementation. Processing may begin at block 1002.

Block 1002 (Execute Application) may refer to application control unit 660 executing an application that controls operations of at least one of message receiving unit 610, data receiving unit 620, icon determining unit 630, icon displaying unit 640 and signal generating unit 650. Processing may proceed from block 1002 to block 1004.

Block 1004 (Receive Message) may refer to message receiving unit 610 receiving, from at least one of server 105 or television device 110, a message that indicates that television device 110 is in a state capable of reproducing of television content. Processing may proceed from block 1004 to block 1006.

Block 1006 (Receive Metadata) may refer to data receiving unit 620 receiving metadata regarding the television content that is played by television device 110 from at least one of server 105 or television device 110. At block 1006, data receiving unit 620 may transmit a request for the metadata to at least one of server 105 or television device 110, when message receiving unit 610 receives the message from at least one of server 105 or television device 110 at block 1004. Then, at least one of server 105 or television device 110 may transmit the metadata regarding the television content in response to the request. By way of example, but not limitation, the metadata may include information pertaining to the television content, including, but not limited to: a title, a play time, a genre, a type, a display resolution, a director, an actor or actress. Processing may proceed from block 1006 to block 1008.

Block 1008 (Determine Icons) may refer to icon determining unit 630 determining multiple icons based at least in part on the metadata. In some embodiments, at block 1008, icon determining unit 630 may read genre of the television content from the metadata. Further, icon determining unit 630 may determine icons that are associated with the television content played by television device 110 based on the read genre of the television content. In some other embodiments, at block 1008, icon determining unit 630 may read type of the television content from the metadata. By way of example, but not limitation, the type of the television content includes at least one of a real-time broadcasting type, a video-on-demand type, a music playing type, a web service type, or an interactive service type. Further, icon determining unit 630 may determine icons that are associated with the television content played by television device 110 based on the read type of the television content.

In some other embodiments, the metadata received at block 1006 may include multiple sub-metadata, each of which is associated with television content. Icon determining unit 630 may select some sub-metadata that is associated with the television content that is played by television device 110 from among the multiple sub-metadata. Then, icon determining unit 630 may determine multiple icons to be displayed based at least in part on the selected sub-metadata. Processing may proceed from block 1008 to block 1010.

Block 1010 (Display Icons) may refer to icon displaying unit 640 displaying the multiple icons that are associated with the television content played by television device 110 and determined at block 1008. Processing may proceed from block 1010 to block 1012.

Block 1012 (Receive Touch Input) may refer to icon displaying unit 640 receiving a touch input via at least one icon from among the multiple icons displayed at block 1010. Processing may proceed from block 1012 to block 1014.

Block 1014 (Generate Control Signal) may refer to signal generating unit 650 generating a control signal regarding an operation of television device 110 based at least in part on the touch input to the at least one icon, which is received at block 1012. By way of example, at block 1014, signal generating unit 650 may generate a control signal that requests for server 105 to transmit a control signal to television device 110 to execute an operation that is associated with the touched icon. Processing may proceed from block 1014 to block 1016.

Block 1016 (Transmit Control Signal) may refer to signal generating unit 650 transmitting the control signal regarding the operation of television device 110, which is generated at block 1014, to at least one of server 105 or television device 110.

Thus, FIG. 10 shows another example processing flow of operations for implementing at least portions of a content based user interface, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

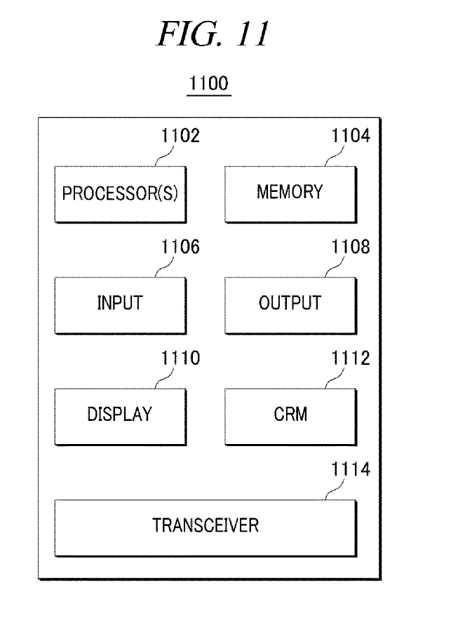

FIG. 11 shows an illustrative computing embodiment, in which any of the processes and sub-processes of a content based user interface may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 1100 may typically include, at least, one or more processors 1102, a system memory 1104, one or more input components 1106, one or more output components 1108, a display component 1110, a computer-readable medium 1112, and a transceiver 1114.

Processor 1102 may refer to, e.g., a microprocessor, a microcontroller, a digital signal processor, or any combination thereof.

Memory 1104 may refer to, e.g., a volatile memory, non-volatile memory, or any combination thereof. Memory 1104 may store, therein, an operating system, an application, and/or program data. That is, memory 1104 may store executable instructions to implement any of the functions or operations described above and, therefore, memory 1104 may be regarded as a computer-readable medium.

Input component 1106 may refer to a built-in or communicatively coupled keyboard, touch screen, or telecommunication device. Alternatively, input component 1106 may include a microphone that is configured, in cooperation with a voice-recognition program that may be stored in memory 1104, to receive voice commands from a user of computing device 1100. Further, input component 1106, if not built-in to computing device 1100, may be communicatively coupled thereto via short-range communication protocols including, but not limitation, radio frequency or Bluetooth.

Output component 1108 may refer to a component or module, built-in or removable from computing device 1100, which is configured to output commands and data to an external device.

Display component 1110 may refer to, e.g., a solid state display that may have touch input capabilities. That is, display component 1110 may include capabilities that may be shared with or replace those of input component 1106.

Computer-readable medium 1112 may refer to a separable machine readable medium that is configured to store one or more programs that embody any of the functions or operations described above. That is, computer-readable medium 1112, which may be received into or otherwise connected to a drive component of computing device 1100, may store executable instructions to implement any of the functions or operations described above. These instructions may be complimentary or otherwise independent of those stored by memory 1104.

Transceiver 1114 may refer to a network communication link for computing device 1100, configured as a wired network or direct-wired connection. Alternatively, transceiver 1114 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A mobile device, comprising:
a data receiving unit configured to receive metadata regarding television content that is played by a television device;
an icon displaying unit configured to:
display a plurality of icons that are associated with the television content based at least in part on the metadata, and
receive a touch input via at least one icon from among the plurality of icons; and
a signal generating unit configured to generate a control signal regarding an operation of the television device based at least in part on the received touch input.

2. The mobile device of claim 1, wherein the signal generating unit is further configured to transmit the control signal to a server that controls the operation of the television device, and
wherein the data receiving unit is further configured to receive the metadata from the server.

3. The mobile device of claim 2, further comprising:
a message receiving unit configured to receive, from the server, a message that indicates that the television device is capable of reproducing the television content,
wherein the data receiving unit is further configured to transmit a request for the metadata to the server, when the message receiving unit receives the message.

4. The mobile device of claim 1, further comprising:
an application control unit configured to host an application that controls operations of at least one of the data receiving unit, the icon displaying unit, or the signal generating unit.

5. The mobile device of claim 1, wherein the received metadata includes a plurality of sub-metadata, and
wherein the mobile device further comprises:
an icon determining unit configured to:
select sub-metadata, which is associated with the television content, from among the plurality of sub-metadata, and
determine the plurality of icons based at least in part on the selected sub-metadata.

6. The mobile device of claim 1, further comprising:
an icon determining unit configured to:
read a genre of the television content from the metadata; and
determine the plurality of icons based at least in part on the read genre of the television content.

7. The mobile device of claim 1, further comprising:
an icon determining unit configured to:
read a type of the television content from the metadata; and
determine the plurality of icons based at least in part on the read type of the television content,
wherein the type of the television content includes at least one of a real-time broadcasting type, a video-on-demand type, a music playing type, a web service type, or an interactive service type.

8. The mobile device of claim 1, wherein the icon displaying unit is further configured to display at least one personalized icon based at least in part on a viewing log of a user of the mobile device.

9. The mobile device of claim 1, wherein the data receiving unit is configured to receive the metadata from the television device, and
wherein the signal generating unit is further configured to transmit the control signal to the television device.

10. The mobile device of claim 9, further comprising:
a message receiving unit configured to receive, from the television device, a message that indicates that the television device is capable of reproducing the television content, and
wherein the data receiving unit is further configured to transmit a request for the metadata to the television device, when the message receiving unit receives the message.

11. A method implemented by a mobile device having a user interface, comprising:
receiving metadata regarding television content that is played by a television device;
displaying a plurality of icons that are associated with the television content based at least in part on the metadata;
receiving a touch input via at least one icon from among the plurality of icons; and
generating a control signal regarding an operation of the television device based at least in part on the received touch input.

12. The method of claim 11, further comprising:
transmitting the control signal to a server that controls the operation of the television device,
wherein the metadata is received from the server.

13. The method of claim 12, further comprising, prior to the receiving of the metadata:
receiving, from the server, a message that indicates that the television device is capable of reproducing the television content; and
transmitting a request for the metadata to the server, when the message is received.

14. The method of claim 11, further comprising:
executing, on the mobile device, an application that controls at least one of the receiving of the metadata, displaying of the plurality of icons, or generating of the control signal.

15. The method of claim 11, further comprising:
reading a genre of the television content from the metadata; and
determining the plurality of icons based at least in part on the read genre of the television content.

16. The method of claim 11, further comprising:
reading a type of the television content from the metadata; and
determining the plurality of icons based at least in part on the read type of the television content,
wherein the type of the television content includes at least one of a real-time broadcasting type, a video-on-demand type, a music playing type, a web service type, or an interactive service type.

17. The method of claim 11, wherein the received metadata includes a plurality of sub-metadata, and
wherein the method further comprises:
selecting sub-metadata, which is associated with the television content, from among the plurality of sub-metadata, and
determining the plurality of icons based at least in part on the selected sub-metadata.

18. The method of claim 11, further comprising:
transmitting the control signal to the television device,
wherein the metadata is received from the television device.

19. A computer-readable storage medium having thereon computer-executable instructions that, in response to execution, cause one or more processors corresponding to a mobile device having a user interface to perform operations, comprising:
displaying the user interface that is associated with television content that is played by a television device based at least in part on metadata regarding the television content;
receiving a touch input via at least one icon from among a plurality of icons included in the user interface; and
generating a control signal regarding an operation of the display device based at least in part on the received touch input.

20. The computer-readable storage medium of claim 19, wherein the operations further comprise:
transmitting the control signal to a server that controls the operation of the television device,
wherein the metadata is received from the server.
